(19) United States
(12) Patent Application Publication
(10) Pub. No.: US 2025/0138238 A1
(43) Pub. Date: May 1, 2025

(54) OPTICAL WAVEGUIDE DEVICE

(71) Applicant: SHINKO ELECTRIC INDUSTRIES CO., LTD., Nagano (JP)

(72) Inventor: Hisashi KANEDA, Nagano (JP)

(21) Appl. No.: 18/928,655

(22) Filed: Oct. 28, 2024

(30) Foreign Application Priority Data
Oct. 31, 2023 (JP) 2023-186377

(51) Int. Cl. G02B 6/02; G02B 6/12

(52) U.S. Cl. CPC G02B 6/02042; G02B 6/12002

(57) ABSTRACT

An optical waveguide device includes a substrate and an optical waveguide on a surface of the substrate. The optical waveguide includes a first core layer, a second core layer, and a cladding layer covering the first core layer and the second core layer. The first core layer includes a first part at a first height from the surface of the substrate and a second part at a second height from the surface of the substrate. The second height is smaller than the first height. The second core layer is spaced apart from the first core layer and crosses the first core layer in a plan view.

### CROSS-REFERENCE TO RELATED APPLICATION

This application is based upon and claims priority to Japanese Patent Application No. 2023-186377, filed on Oct. 31, 2023, the entire contents of which are incorporated herein by reference.

### FIELD

A certain aspect of the embodiments discussed herein is related to optical waveguide devices.

### BACKGROUND

An optical waveguide device including an optical waveguide is used to transmit and receive optical signals in a data center where various computers and data communications devices are installed. The optical waveguide includes, for example, a substrate, a first cladding layer formed on the substrate, a core layer formed on the first cladding layer, and a second cladding layer formed on the first cladding layer and the core layer (see Japanese Patent No. 6909637).

### SUMMARY

According to an aspect, an optical waveguide device includes a substrate and an optical waveguide on a surface of the substrate. The optical waveguide includes a first core layer, a second core layer, and a cladding layer covering the first core layer and the second core layer. The first core layer includes a first part at a first height from the surface of the substrate and a second part at a second height from the surface of the substrate. The second height is smaller than the first height. The second core layer is spaced apart from the first core layer and crosses the first core layer in a plan view.

The object and advantages of the invention will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF DRAWINGS

FIG. 1 is a plan view of an optical waveguide device according to a first embodiment;

FIGS. 2A through 2C are sectional views of the optical waveguide device according to the first embodiment;

FIGS. 3A through 3G are diagrams illustrating a process of manufacturing an optical waveguide device according to the first embodiment; and

FIGS. 4A and 4B are diagrams illustrating an optical waveguide device according to a second embodiment.

### DESCRIPTION OF EMBODIMENTS

It has been difficult to three-dimensionally arrange multiple core layers in the optical waveguide in the related-art optical waveguide device.

According to an embodiment, an optical waveguide device including an optical waveguide in which multiple core layers are three-dimensionally arranged is provided.

Embodiments of the present invention are described below with reference to the accompanying drawings. In the following description, the same elements are referred to using the same reference numerals, and redundant description thereof may be omitted.

### [a] First Embodiment

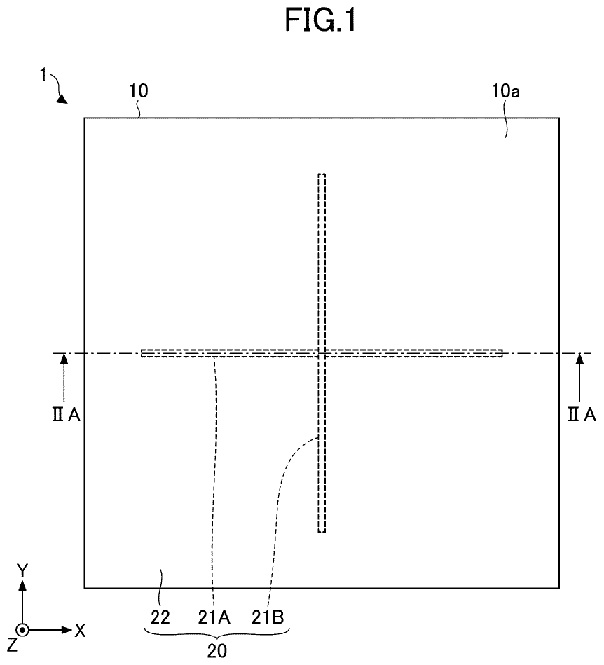

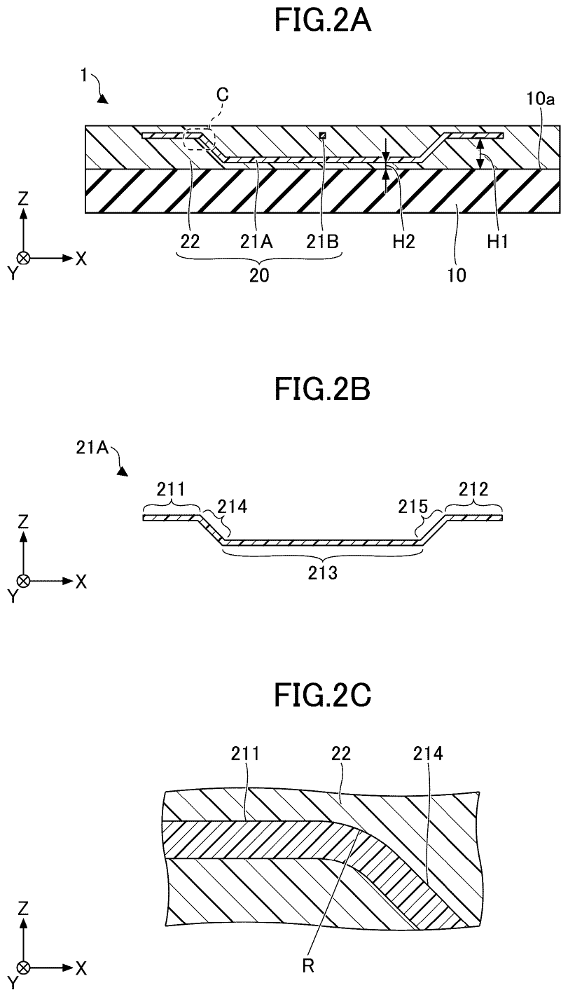

FIG. 1 is a plan view of an optical waveguide device according to a first embodiment. FIGS. 2A through 2C are sectional views of the optical waveguide device according to the first embodiment. FIG. 2A is a sectional view of the optical waveguide device taken along the line IIA-IIA of FIG. 1. FIG. 2B is a sectional view of a first core layer 21A of FIG. 2A. FIG. 2C is an enlarged view of part C of FIG. 2A.

In the drawings, an X-axis, a Y-axis and a Z-axis that are orthogonal to one another are indicated for reference. In the following description, the X direction, the Y direction, and the Z direction collectively refer to directions parallel to the X-axis, directions parallel to the Y-axis, and directions parallel to the Z-axis, respectively. In the X direction, the arrow direction is referred to as “+X direction” and the direction opposite to the +X direction is referred to as “−X direction.” Furthermore, in the Y direction, the arrow direction is referred to as “+Y direction” and the direction opposite to the +Y direction is referred to as “−Y direction.” Furthermore, in the Z direction, the arrow direction is referred to as “+Z direction” and the direction opposite to the +Z direction is referred to as “−Z direction.” These directions, however, do not restrict the orientation of the optical waveguide device and the optical waveguide device may be used in any orientation.

Referring to FIGS. 1 and 2A through 2C, an optical waveguide device 1 includes a substrate 10 and an optical waveguide 20.

The substrate 10 serves as a base body for forming the optical waveguide 20. According to the example illustrated in FIGS. 1 and 2A through 2C, the substrate 10 has a rectangular upper surface 10a, which has two sides parallel to the X direction and two sides parallel to the Y direction. That is, the upper surface 10a of the substrate is parallel to the XY plane. Furthermore, the thickness direction of the substrate 10 is the Z direction. The substrate 10 may be either a rigid substrate with high rigidity or a flexible substrate with low rigidity. For example, the substrate 10 is a build-up substrate. The substrate 10 may be a silicon substrate or a ceramic substrate.

The optical waveguide 20 is stacked on the upper surface 10a of the substrate 10. The optical waveguide 20 includes a first core layer 21A, a second core layer 21B, and a cladding layer 22. The first core layer 21A and the second core layer 21B are covered with the cladding layer 22.

The width of each of the first core layer 21A and the second core layer 21B may be, for example, approximately 5 μm to approximately 10 μm. The thickness of each of the first core layer 21A and the second core layer 21B may be, for example, approximately 5 μm to approximately 10 μm. The refractive index of each of the first core layer 21A and the second core layer 21B is higher than the refractive index of the cladding layer 22, and may be, for example, approximately 1.6. Examples of materials for each of the first core layer 21A and the second core layer 21B include photosensitive resins such as polyimide resin, acrylic resin, epoxy resin, polyolefin resin and polynorbornene resin.

The cladding layer 22 is formed on the upper surface 10a of the substrate 10. The thickness of the cladding layer 22 may be, for example, approximately 70 μm to approximately 100 μm. The refractive index of the cladding layer 22 is lower than the refractive index of each of the first core layer 21A and the second core layer 21B, and may be, for example, approximately 1.5. The cladding layer 22 may be formed of, for example, a material suitably selected from those illustrated as examples of materials for the first core layer 21A and the second core layer 21B.

The first core layer 21A, for example, rectilinearly extends in the X direction in a plan view. The first core layer 21A may include a curved portion in a plan view. In the specification, a plan view refers to a view in a direction normal to the upper surface 10a of the substrate 10.

The first core layer 21A includes portions that are different in height from (positioned at different levels relative to) the upper surface 10a of the substrate 10. Specifically, the first core layer 21A includes a part (first part) positioned at a first height H1 from the upper surface 10a of the substrate 10 and a part (second part) positioned at a second height H2 from the upper surface 10a of the substrate 10. The second height H2 is smaller than the first height H1. Here, the height of each of the first core layer 21A and the second core layer 21B is defined by the distance between the upper surface 10a of the substrate and the lower surface (surface facing the upper surface 10a) of each of the first core layer 21A and the second core layer 21B in the Z direction. Two parts are at the same height from the upper surface 10a of the substrate 10 if the difference in height between the two parts is within ±2 μm.

According to the example illustrated in FIG. 2B, the first core layer 21A includes a first portion 211, a second portion 212, a third portion 213, a fourth portion 214, and a fifth portion 215.

The first portion 211 and the second portion 212 extends parallel to the upper surface 10a of the substrate at the first height H1 from the upper surface 10a of the substrate 10 and are separate (spaced apart) from each other. The third portion 213 is positioned between the first portion 211 and the second portion 212 in the X direction and is separate from the first portion 211 and the second portion 212. The third portion 213 extends parallel to the upper surface 10a of the substrate 10 at the second height H2, which is smaller than the first height H1, from the upper surface 10a of the substrate 10. Being parallel to the upper surface 10a of the substrate 10 allows a difference within +5 degrees.

The fourth portion 214 is positioned between the first portion 211 and the third portion 213 in the X direction. The fourth portion 214 connects the first portion 211 and the third portion 213 and extends unparallel to the upper surface 10a of the substrate 10. That is, the fourth portion 214 is inclined to the upper surface 10a of the substrate 10. The fourth portion 214 may be inclined at any angle to the upper surface 10a of the substrate 10.

The fifth portion 215 is positioned between the second portion 212 and the third portion 213 in the X direction. The fifth portion 215 connects the second portion 212 and the third portion 213 and extends unparallel to the upper surface 10a of the substrate 10. That is, the fifth portion 215 is inclined to the upper surface 10a of the substrate 10. The fifth portion 215 is inclined in a direction different from the direction in which the fourth portion 214 is inclined. The fifth portion 215 may be inclined at any angle to the upper surface 10a of the substrate 10.

The second core layer 21B, for example, rectilinearly extends in the Y direction in a plan view. The second core layer 21B may include a curved portion in a plan view.

The second core layer 21B extends parallel to the upper surface 10a of the substrate 10 at the first height H1 from the upper surface 10a of the substrate 10. That is, the second core layer 21B is positioned at the same height as the first portion 211 and the second portion 212 of the first core layer 21A relative to the upper surface 10a of the substrate 10. The second core layer 21B is separate (spaced apart) from the first core layer 21A and crosses the first core layer 21A in a plan view. Specifically, the second core layer 21B crosses the third portion 213 of the first core layer 21A in a plan view.

The difference between the first height H1 and the second height H2 is preferably 50 μm or more. When the difference between the first height H1 and the second height H2 is 50 μm or more, it is possible to reduce the possibility that light propagating in the second core layer 21B and light propagating in the first core layer 21A interfere with each other where the second core layer 21B crosses the first core layer 21A in a plan view.

In the first core layer 21A, the first portion 211 and the fourth portion 214 may be connected by a bent portion, but preferably by a curved portion as illustrated in FIG. 2C (part of a sectional view of the optical waveguide 20 taken along a plane perpendicular to the upper surface 10a of the substrate 10, which plane is along the first core layer 21A). The same is the case with the connection of the fourth portion 214 and the third portion 213, the connection of the third portion 213 and the fifth portion 215, and the connection of the fifth portion 215 and the second portion 212. The connection is bent (a bent portion) when the outer side of the connection is bent at a single point (in the sectional view), and is curved (a curved portion) when the outer side of the connection is gently curved over a certain area.

A radius of curvature R of the outer side of the curved portion illustrated in FIG. 2C is preferably 5 mm or more. When the radius of curvature R of the outer side of the curved portion is 5 mm or more, light that has traveled through the first portion 211 does not travel straight and is likely to travel toward the fourth portion 214 along the shape of the curved portion. Furthermore, light that has traveled through the fourth portion 214 does not travel straight and is likely to travel toward the first portion 211 along the shape of the curved portion. That is, light traveling through the first core layer 21A is less likely to leak from the first core layer 21A to the cladding layer 22. The same is the case with the connection of the fourth portion 214 and the third portion 213, the connection of the third portion 213 and the fifth portion 215, and the connection of the fifth portion 215 and the second portion 212.

Thus, according to the optical waveguide device 1, the first core layer 21A and the second core layer 21B are disposed at positions that are different in height from the upper surface 10a of the substrate 10, and the first core layer 21A and the second core layer 21B cross in a plan view. That is, it is possible to produce the optical waveguide device 1 including the optical waveguide 20 in which multiple core layers are three-dimensionally arranged. This makes it possible to increase latitude in arranging one or more of a photonic integrated circuit, a light emitter, and a light receiver that input light to and receive light exiting from the optical waveguide 20.

The optical waveguide device 1 may include multiple core layers having the same shape as the first core layer 21A, and may include multiple core layers having the same shape as the second core layer 21B.

The optical waveguide device 1, which includes the two layers of the first core layer 21A and the second core layer 21B, may include three or more core layers.

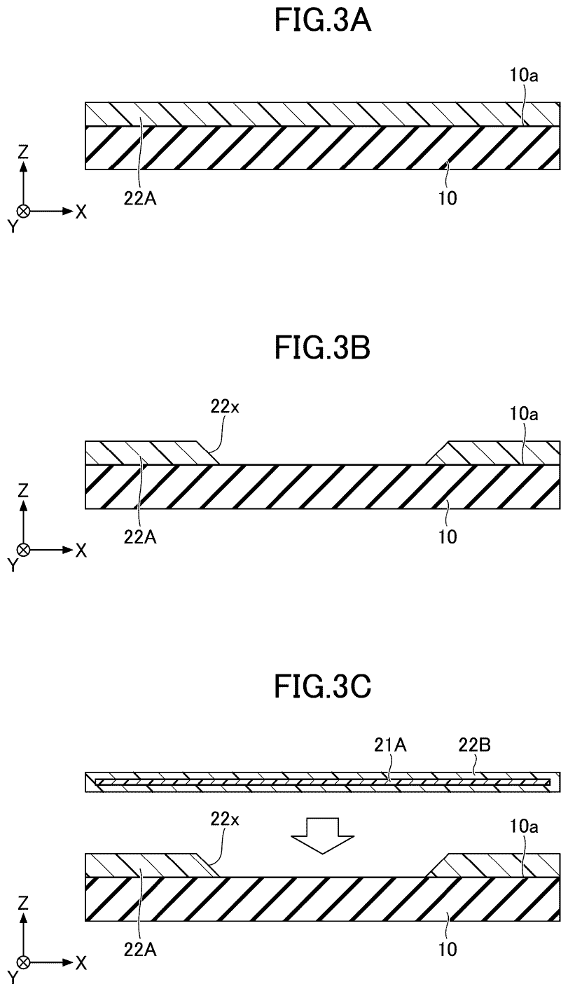

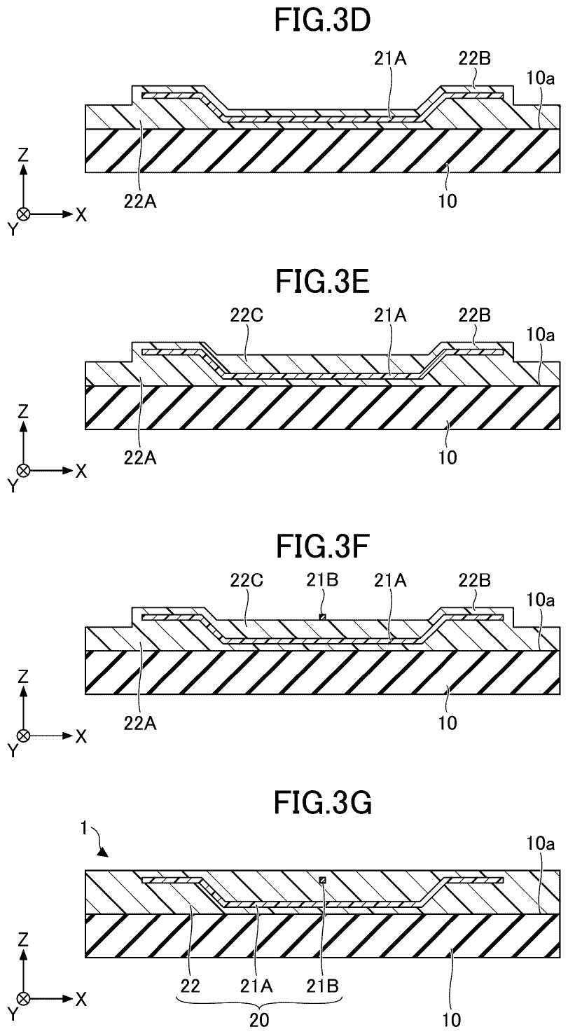

Next, a method of manufacturing the optical waveguide device 1 is described. FIGS. 3A through 3G are diagrams illustrating a process of manufacturing an optical waveguide device according to the first embodiment.

According to the method of manufacturing an optical waveguide device of the first embodiment, first, in the process illustrated in FIG. 3A, the substrate 10 is prepared and a cladding layer 22A is formed on the upper surface 10a of the substrate 10. The substrate 10 may be of any type, and may be manufactured using, for example, a known build-up process or the like. The substrate 10 may be prepared by purchasing a commercially available product. The cladding layer 22A, which is a member that ultimately constitutes part of the cladding layer 22, is formed to be thinner than the cladding layer 22. The cladding layer 22 may be formed by, for example, placing a semi-cured resin film on the upper surface 10a of the substrate 10 and thereafter hardening the film by exposure to ultraviolet radiation. Alternatively, resin liquid or paste may be used in place of a resin film. The cladding layer 22A may be formed of, for example, a material suitably selected from those illustrated as examples of materials for the cladding layer 22.

Next, in the process illustrated in FIG. 3B, a recess 22x is formed in the cladding layer 22A. The recess 22x may have a shape widening in the +Z direction from the upper surface 10a of the substrate 10. The recess 22x may have the same cross-sectional shape irrespective of a position in the Y direction. The recess 22x preferably has a depth of 50 μm or more to prevent interference of light between the first core layer 21A and the second core layer 21B. The recess 22x may be formed using etching and mechanical processing in combination. The inclined surface of the recess 22x may be a flat surface, a curved surface, or a mixture thereof. The recess 22x preferably has a rounded corner so that the first core layer 21A may have the curved portion illustrated in FIG. 2C in a subsequent process.

In the illustration of FIG. 3B, the recess 22x is formed in such a manner as to expose the upper surface 10a of the substrate 10. The recess 22x, however, may alternatively be formed without exposing the upper surface 10a of the substrate 10. That is, part of the cladding layer 22A may remain at the bottom of the recess 22x. It is preferable to form the recess 22x in such a manner as to expose the upper surface 10a of the substrate 10 in terms of making the optical waveguide device 1 low-profile in its entirety.

Next, in the process illustrated in FIG. 3C, a film-shaped optical waveguide including the first core layer 21A and a cladding layer 22B covering the first core layer 21A is prepared, and is placed along the recess 22x. Here, by way of example, the film-shaped optical waveguide is placed such that the first core layer 21A rectilinearly extends in the X direction in a plan view. The film-shaped optical waveguide may be manufactured by a known method or be purchased. The material and the thickness of the first core layer 21A are as described above. The cladding layer 22B, which is a member that ultimately constitutes part of the cladding layer 22, is preferably as thin as approximately 20 μm to approximately 50 μm. The material of the cladding layer 22B may be the same as the material of the cladding layer 22A.

Next, in the process illustrated in FIG. 3D, the cladding layer 22B is hardened by exposure to ultraviolet radiation.

Next, in the process illustrated in FIG. 3E, a cladding layer 22C is formed in the recess 22x to adjust a height at which the second core layer 21B is placed in a subsequent process. The material of the cladding layer 22C may be the same as the material of the cladding layer 22A. The cladding layer 22C may be formed in the same manner as the cladding layer 22A.

Next, in the process illustrated in FIG. 3F, the second core layer 21B in film form is placed on the cladding layer 22C. Here, by way of example, the second core layer 21B is placed to rectilinearly extend in the Y direction in a plan view. The material and the thickness of the second core layer 21B are as described above.

Next, in the process illustrated in FIG. 3G, a cladding layer to cover the second core layer 21B is formed. As a result, the cladding layer 22 having a flat upper surface is formed. The material of this cladding layer may be the same as the material of the cladding layer 22A. This cladding layer may be formed in the same manner as the cladding layer 22A. In the cladding layer 22, the interfaces between the cladding layers stacked in the manufacturing process may be either clear or unclear. As a result, the optical waveguide device 1 is completed.

Thus, according to the method of manufacturing an optical waveguide device of the first embodiment, a recess is provided in a cladding layer placed on a substrate, a film-shaped optical waveguide is placed along the recess, and cladding layers and a core layer are further formed, so that multiple core layers can be crossed. In the case of crossing multiple core layers, it has been common to employ special parts and materials such as switches and reflective mirrors. Furthermore, in the case of using switches and reflective mirrors, it is difficult to increase the yield of optical waveguides. In contrast, according to the manufacturing method of the first embodiment, the optical waveguide device 1 including the optical waveguide 20 in which multiple core layers are three-dimensionally arranged can be produced with high yield in a simple manner without using special parts or materials.

### [b] Second Embodiment

In a second embodiment, the case of mounting a photonic integrated circuit (PIC) on an optical waveguide device according to the first embodiment is illustrated. In the second embodiment, description of the same elements or components as those of the above-described embodiment may be omitted.

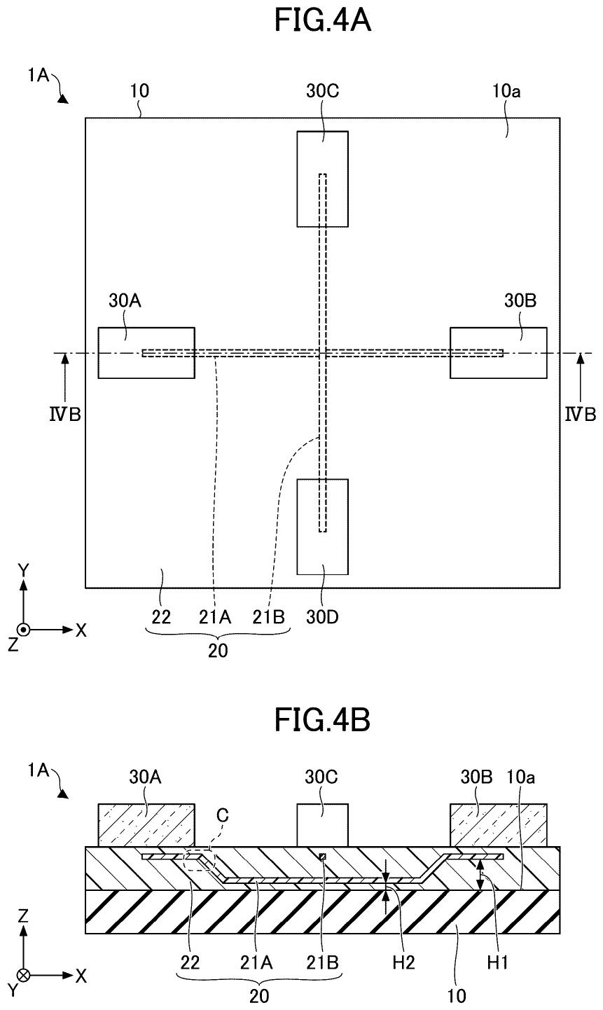

FIGS. 4A and 4B are diagrams illustrating an optical waveguide device according to the second embodiment. FIG. 4A is a plan view of the optical waveguide device, and FIG. 4B is a sectional view of the optical waveguide device taken along the line IVB-IVB of FIG. 4A.

Referring to FIGS. 4A and 4B, an optical waveguide device 1A includes the substrate 10, the optical waveguide 20, a photonic integrated circuit 30A (a first photonic integrated circuit), a photonic integrated circuit 30B (a second photonic integrated circuit), a photonic integrated circuit 30C (a third photonic integrated circuit), and a photonic integrated circuit 30D (a fourth photonic integrated circuit). The photonic integrated circuit 30A, the photonic integrated circuit 30B, the photonic integrated circuit 30C, and the photonic integrated circuit 30D are arranged on the cladding layer 22 of the optical waveguide 20. The photonic integrated circuit is an integrated circuit that can communicate both an electrical signal and an optical signal. The photonic integrated circuit may or may not include the function of a light emitter or a light receiver. When the photonic integrated circuit does not include the function of a light emitter or a light receiver, a light emitter or a light receiver may be provided separately from the photonic integrated circuit.

The photonic integrated circuit 30A is positioned near one end of the first core layer 21A and the photonic integrated circuit 30B is positioned near the other end of the first core layer 21A. For example, the photonic integrated circuit 30A is positioned over the first portion 211 illustrated in FIG. 2B, and the photonic integrated circuit 30B is positioned over the second portion 212 illustrated in FIG. 2B. For example, light transmitted from the photonic integrated circuit 30A may propagate through the first core layer 21A to be received by the photonic integrated circuit 30B.

The photonic integrated circuit 30C is positioned near one end of the second core layer 21B and the photonic integrated circuit 30D is positioned near the other end of the second core layer 21B. For example, light transmitted from the photonic integrated circuit 30C may propagate through the second core layer 21B to be received by the photonic integrated circuit 30D.

According to the optical waveguide device 1A, because multiple core layers are three-dimensionally arranged in the optical waveguide 20, it is possible to increase latitude in arranging photonic integrated circuits.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. An optical waveguide device comprising:
a substrate; and
an optical waveguide on a surface of the substrate,
the optical waveguide including
a first core layer including
a first part at a first height from the surface of the substrate; and
a second part at a second height from the surface of the substrate, the second height being smaller than the first height;
a second core layer spaced apart from the first core layer and crossing the first core layer in a plan view; and
a cladding layer covering the first core layer and the second core layer.

2. The optical waveguide device as claimed in claim 1, wherein the second core layer extends parallel to the surface of the substrate at the first height.

3. The optical waveguide device as claimed in claim 1, wherein a difference between the first height and the second height is 50 μm or more.

4. The optical waveguide device as claimed in claim 1, wherein
the first core layer includes
a first portion and a second portion extending parallel to the surface of the substrate at the first height, the first portion and the second portion being apart from each other;
a third portion extending parallel to the surface of the substrate at the second height;
a fourth portion connecting the first portion and the third portion, the fourth portion extending unparallel to the surface of the substrate; and
a fifth portion connecting the second portion and the third portion, the fifth portion extending unparallel to the surface of the substrate.

5. The optical waveguide device as claimed in claim 4, wherein the second core layer crosses the third portion in the plan view.

6. The optical waveguide device as claimed in claim 4, wherein a connection of the first portion and the fourth portion, a connection of the fourth portion and the third portion, a connection of the third portion and the fifth portion, and a connection of the fifth portion and the second portion are curved.

7. The optical waveguide device as claimed in claim 6, wherein a radius of curvature of an outer side of each of the curved connections is 5 mm or more in a sectional view.

8. The optical waveguide device as claimed in claim 1, wherein the first core layer and the second core layer cross at right angles in the plan view.

9. The optical waveguide device as claimed in claim 1, wherein the first core layer rectilinearly extends in the plan view.

10. The optical waveguide device as claimed in claim 1, wherein the first core layer includes a third part inclined to the surface of the substrate.

11. The optical waveguide device as claimed in claim 1, further comprising:
a first photonic integrated circuit on the cladding layer at a position over an end of the first core layer;
a second photonic integrated circuit on the cladding layer at a position over another end of the first core layer;
a third photonic integrated circuit on the cladding layer at a position over an end of the second core layer; and
a fourth photonic integrated circuit on the cladding layer at a position over another end of the second core layer.
